(19) United States
(12) Patent Application Publication
(10) Pub. No.: US 2025/0137194 A1
(43) Pub. Date: May 1, 2025

(54) SYNTHETIC OR FOAMED SYNTHETIC MATERIAL COATED WITH BIO-BASED FORMULATION

(71) Applicant: LEATHEIST LLP, Nashik, Maharashtra (IN)

(72) Inventor: Aishwarya Kirtane, Nashik, Maharashtra (IN)

(73) Assignee: LEATHEIST LLP, Nashik, Maharashtra (IN)

(21) Appl. No.: 18/836,308

(22) PCT Filed: Feb. 6, 2023
(86) PCT No.: PCT/IN2023/050119

§ 371 Date: Aug. 6, 2024

(30) Foreign Application Priority Data
Feb. 7, 2022 (IN) 202221006546

(51) Int. Cl. D06M 15/01; D06M 15/643; D06M 15/705

(52) U.S. Cl. CPC D06M 15/01; D06M 15/643; D06M 15/705; D06M 2200/40; D10B 2401/063; D10B 2403/02421

(57) ABSTRACT

The present invention relates to a synthetic material coated with a bio-based formulation comprising residual wastes, an eco-friendly process for preparing the formulation from residual wastes to obtain a synthetic material which is a high value-added material

### FIELD OF THE INVENTION

The present invention relates to a synthetic or foamed synthetic material coated with bio-based formulation comprising residual wastes, and more particularly, an eco-friendly process for preparing the bio-based formulation from residual wastes, a process for preparing the synthetic or foamed synthetic material which is a high value-added biomaterial.

### BACKGROUND ART

The fashion industry is one of the most polluting sectors that has been created in recent years. It is responsible for 10% of annual global C emissions and 20% of wastewater. To put that in perspective, the carbon emissions of fashion are worse than that of international flights and maritime shipping combined. Thus, it has been estimated that if no changes are incorporated, the fashion industry will constitute 26% of global carbon emissions. In recent years, concerns over sustainability in any field of industrial production have led to a pressing rationale to enhance the use of natural materials and replace non-renewable fossil-based raw materials. Synthetic alternatives usually consist of textile support covered by two or more synthetic polymer layers. Nowadays, often polyester textiles coated by PVC or polyurethane films are used, making them a completely fossil-based material. However, these synthetic materials face several problems, namely solid waste, toxic chemical effluents, water pollution, microplastics released when washed, and lengthy processes. A large number of synthetic materials are based on the use of polyvinyl chloride (PVC), polyurethane (PU), or mixtures thereof. However, PVC-based products have the disadvantage that toxic hydrogen chloride (HCl) is generated during combustion. The use of starting materials containing chlorine also hurts the eco-balance of such products.

In particular, the inventors of the present invention have observed that the fabric segment of the industry is riddled with errors. There are severe problems involved, in both, genuine and artificial fabrics. A sustainable solution to leather is the need of the hour and both the existing alternatives are not feasible in the long run. Predominantly, the problems associated with conventional techniques include toxic chemical effluents, solid waste, animal cruelty, use of toxic chemicals, water pollution, and lengthy processes. Further, it is to be noted that these processes are also water intensive. The eco-balance of known artificial fabric is also generally not very good since petroleum-based raw materials are used as starting materials and therefore sustainable production is not possible.

Further, along with above problems such as toxic chemical effluents, solid waste, animal cruelty, use of toxic chemicals, water pollution, and lengthy processes, there is another concern of use or disposal of agricultural waste which could be between 15-20%. Agriculture is contributing towards the food & nutritional security of our people, and economic growth of the country, improper management of agricultural waste generated in the process has been contributing towards mounting air, soil and water pollution. In India, which is the second largest agro-based economy in the world and employs a year-long cultivation system (FAOSTAT 2020), 500 million tonnes of agricultural residues are generated annually. After their utilization as fuel, fodder and other domestic and industrial uses, a surplus of about 140 million tonnes of residues remains, of which about 92 million tonnes are burnt. For most farmers, residue burning is a convenient route with negligible costs for preparing the field for the next sowing season, as opposed to hiring combines to remove residues (Vivek Adhia, Mishra, A., Banerjee, D., Nambi Appadurai, A., Preethan, P., Khan, Y., de Wagenaar, D., Harmsen, P., Elbersen, B., van Eupen, M., Staritsky, I., Elbersen, W., & Keijsers, E. (2021). Spinning future threads: the potential of agricultural residues as textile fibre feedstock. https://edepot.wur.nl/555522.)

A study by the Indian Agricultural Research Institute estimated that residue burning releases 149.24 million tonnes of carbon dioxide, 9 million tonnes of carbon monoxide, 0.25 million tonnes of sulphur oxides, 1.28 million tonnes of particulate matter and 0.07 million tonnes of black carbon each year (Jitendra et al. 2017). This adversely affects air quality levels in the region, and especially for nearby towns and cities, endangering both the environment and society.

So far, the only application for most agricultural waste in India is as cattle feed, in contrast, rice straw, banana stems and other agricultural waste could very well be utilized for producing eco-friendly products such as textile fibers that could provide the triple benefits of increased farmers' incomes, sustainable fashion and a reduced detrimental impact on the environment.

Agriculture-residue based fibers are one such class of innovations that holds promise and could potentially speak to dual objectives. One, as a solution to the fashion industry's search for alternatives and in parallel, a pathway for millions of farmers who burn their crop residues and set off dangerous levels of emissions for the want of better options. There have been many innovations regarding the use of such agricultural waste products in the fashion industry, however, the practical applications of such waste residues at commercial scale are still in developmental stages.

Accordingly, to overcome the limitations of the existing products and methods of production, the present invention provides a unique formulation for preparing synthetic material coated with a bio-based formulation and a process for preparing the same. Further, the synthetic material is free from animal cruelty, eco-friendly, and has a much lesser carbon footprint than its conventionally known alternatives.

### SUMMARY OF THE INVENTION

The present invention relates to a synthetic or foamed synthetic material coated with bio-based formulation comprising residual wastes, and more particularly, an eco-friendly process for preparing the bio-based formulation from residual wastes, a process for preparing the synthetic or foamed synthetic material.

The present invention uses agricultural residues like corn cob, rice husk, grain husk, solid coffee waste, peanut shells, fruit residues, walnut shells, pistachio shells, or a combination thereof and converts it to a high value-added biomaterial.

### Objective of the Invention

An object of the present invention is to provide a synthetic or foamed synthetic material coated with a bio-based formulation composed of agricultural waste residues.

An object of the present invention is to provide a bio-based formulation from agricultural waste residues like corn cob, rice husk, grain husk, solid coffee waste, or peanut shells.

An object of the present invention is to provide a process for preparing the bio-based formulation from residual wastes.

An object of the present invention is to provide a method for coating the formulation on a fabric material to obtain a synthetic material wherein the synthetic or foamed synthetic material is a high value-added product.

An object of the present invention is to provide a high value-added synthetic or foamed synthetic material which can be used as leather for various products, coated paper to use for luxurious packaging boxes and stationery like covers for diaries, shoe insoles and also has application in injection molding to prepare solid articles.

### BRIEF DESCRIPTION OF FIGURES

The accompanying drawings illustrate some of the embodiments of the present invention and, together with the descriptions, serve to explain the invention. These drawings have been provided by way of illustration and not by way of limitation. The components in the drawings are not necessarily drawn to scale, emphasis instead being placed upon clearly illustrating the principles of the aspects of the embodiments.

FIG. 1: Graph of stress (N/mm²) Vs Elongation (%) in along direction for sample 1

FIG. 2: Graph of stress (N/mm²) Vs Elongation (%) in along direction for sample 2

FIG. 3: Graph of stress (N/mm²) Vs Elongation (%) in along direction for sample 3

FIG. 4: Graph of stress (N/mm²) Vs Elongation (%) in along direction for sample 4

FIG. 5: Graph of stress (N/mm²) Vs Elongation (%) in along direction for sample 5

FIG. 6: Graph of stress (N/mm²) Vs Elongation (%) in across direction for sample 1

FIG. 7: Graph of stress (N/mm²) Vs Elongation (%) in across direction for sample 2

FIG. 8: Graph of stress (N/mm²) Vs Elongation (%) in across direction for sample 3

FIG. 9: Graph of stress (N/mm²) Vs Elongation (%) in across direction for sample 4

FIG. 10: Graph of stress (N/mm²) Vs Elongation (%) in across direction for sample 5

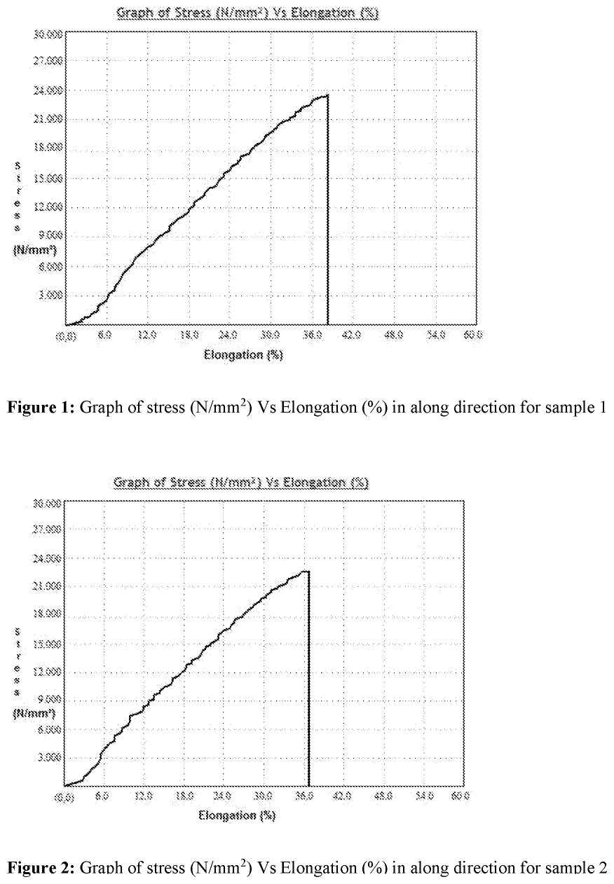

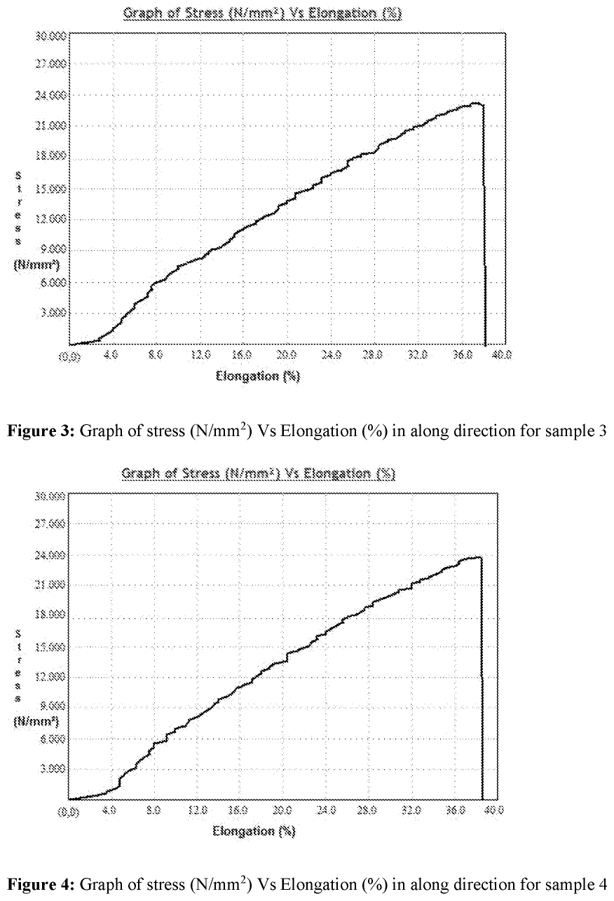

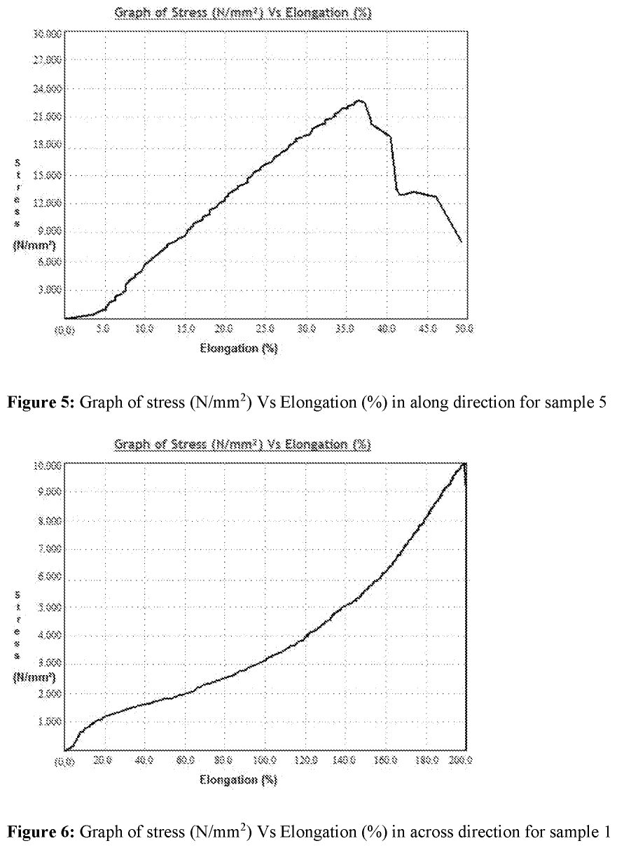

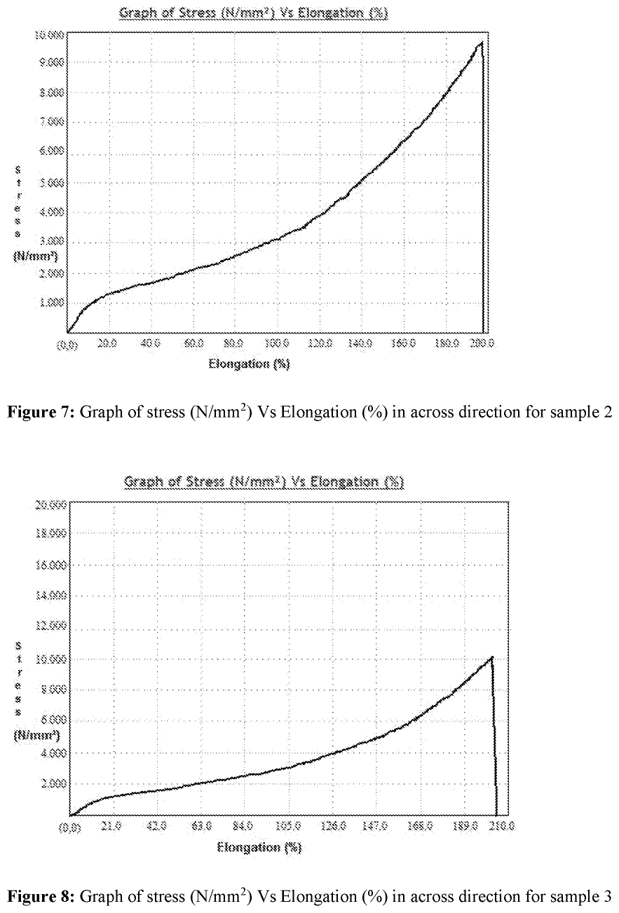

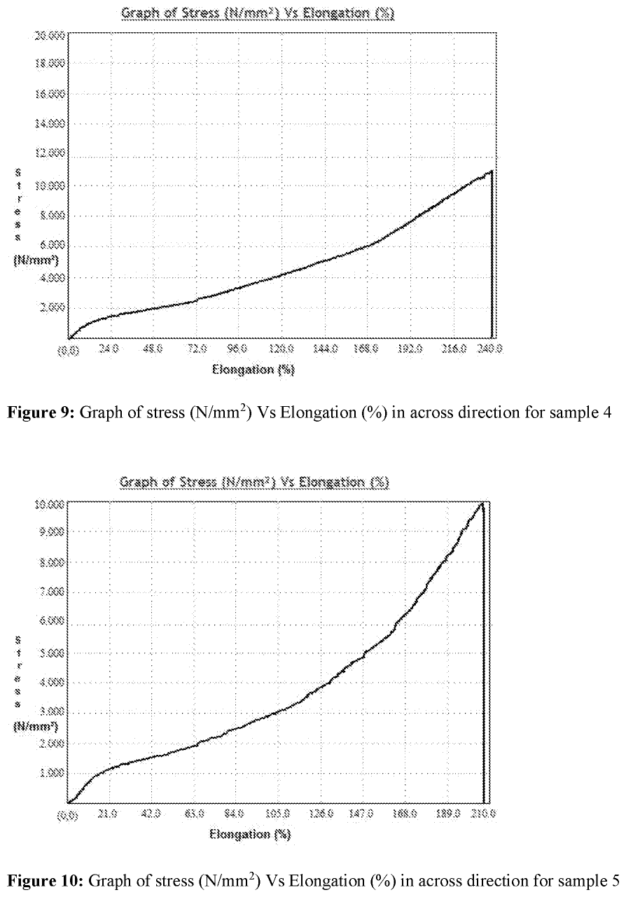

### DETAILED DESCRIPTION OF THE INVENTION

The present invention is now described concerning the tables/figures and specific embodiments, including the best mode contemplated by the inventors for carrying out the invention. This description is not meant to be construed in a limiting sense, as various alternative embodiments of the invention will become apparent to persons skilled in the art, upon reference to the description of the invention. It is therefore contemplated that such alternative embodiments form part of the present invention.

Unless defined otherwise, technical, and scientific terms used herein have the same meaning as commonly understood by one of ordinary skill in the art to which this invention belongs. Further, unless otherwise required by context, singular terms shall include pluralities, and plural terms shall include the singular. Generally, nomenclatures utilized in connection with, and techniques of, cell and tissue culture, molecular biology, and protein and oligo- or polynucleotide chemistry and hybridization described herein are those well-known and commonly used in the art. Some of the terms are defined briefly here below; the definitions should not be construed in a limiting sense.

The inventors of the present invention have aimed to recycle the agricultural waste residue like corn cob, rice husk, grain husk, solid coffee waste, peanut shells, fruit residues, walnut shells, pistachio shells, or a combination thereof and convert it to a high-value product. For the same, the present invention relates to synthetic material that is free from animal cruelty, eco-friendly, and has a much lesser carbon footprint than its conventionally known alternatives.

The inventors of the present invention have developed a bio-based formulation for preparing synthetic material, along with an easy to perform process for preparing the synthetic material. The bio-based formulation may optionally comprise an additive that promotes biodegradability. The additive was purchased from Bio-Tec Environmental, LLC. Addition of such foaming agents depends on the end use of the material. Foamed synthetic materials tend to produce results that tend to be softer and have better drapability. However, non-foamed products have more strength, more structure, and can get more ARW to make a stiffer end product.

The process of the present invention is easy to perform and comprises blending all the raw material, at appropriate concentrations and temperatures below 200° C., to obtain a semi-liquid bioformulation that is coated onto a base fabric to obtain a synthetic material. The final product can be given any type of surface design, given the use of appropriate machinery.

Accordingly, an embodiment of the present invention is to provide a synthetic or foamed synthetic material comprising of a base fabric coated with a bio-based formulation wherein the bio-based formulation comprising:
agricultural residue in a concentration range of 1-65 wt %;
thermoplastic binder/s in a concentration range of 30-90 wt %;
stabilizer in a concentration range of 1-35 wt %;
plasticizer in a concentration range of 3-30 wt %;
optionally additive in a concentration of 0-20 wt %.

An embodiment of the present invention is to provide a synthetic or foamed synthetic material wherein the bio-based formulation is coated on a base fabric which is a non-woven fabric.

An embodiment of the present invention is to provide a synthetic or foamed synthetic material wherein the non-woven fabric is selected from cotton, wool, polyester, cotton-polyester blend, wool-cotton blend, or wool polyester blend.

An embodiment of the present invention is to provide the synthetic or foamed synthetic material wherein the bio-based formulation comprises:
agricultural residue in a concentration range of 5-30 wt %;
thermoplastic binder in a concentration range of 50-85 wt %;
stabilizer in a concentration range of 2-30 wt %;
plasticizer in a concentration range of 5-25 wt %;
additive in a concentration of 0-20 wt %.

An embodiment of the present invention is to provide the bio-based formulation from solid agricultural residue; and wherein the agricultural residue (ARW) is selected from the group consisting of corn cob, rice husk, grain husk, solid coffee waste, peanut shells, fruit residues, walnut shells, pistachio shells, or a combination thereof.

An embodiment of the present invention is to provide the bio-based formulation comprising a thermoplastic binder that is selected from the group consisting of ethylene-vinyl acetate (EVA), polypropylene (pp), Polyethylene (PE), Thermoplastic polyurethane (TPU), low-density polyethylene (LDPE) and high-density polyethylene (HDPE), acrylic, polystyrene, polycarbonate, thermoplastic starch (TPS), Teflon, or a combination thereof.

An embodiment of the present invention is to provide the bio-based formulation wherein the stabilizer is selected from the group consisting of butylated hydroxytoluene, Pentaerythritol tetrakis (3,5-di-tert-butyl-4-hydroxy-hydro cinnamate), epoxidized soybean oil, Tris(2,4-di-tert-butylphenyl) phosphite, bisoctrizole, bemotrizinol, epoxidized palm oil, thiodiethylene bis[3-(3,5-di-tert.-butyl-4-hydroxy-phenyl)propionate], dioctyl adipate, diphenyl isooctyl phosphite, N-isopropyl-N′-phenyl-1,4-phenylenediamine, 3-(4-Hydroxyphenyl) propanoic acid, or a combination thereof.

An embodiment of the present invention is to provide the bio-based formulation wherein the plasticizer is selected from the group consisting of propane-1,2,3-triol, polyethylene glycol, dibutyl sebacate, epoxidized soybean oil (ESBO), epoxidized palm oil (EPO), Di-iso-octyl phthalate (DIOP), Di-iso-nonyl phthalate (DINP), Di-iso-decyl phthalate (DIDP), Acetyl Tri-Butyl Citrate (ATBC), Dioctyl Adipate (DOA), Di(2-Ethylhexyl) Adipate (DEHA), Di-isononyl-1,2-cyclohexanedicarboxylate (DINCH), Di-isononyl Adipate (DINA), Alkylsulphonic Acid Ester of Phenol (ASE), Di-2-ethyl hexyl phthalate (DEHP), glycerol, sorbitol, butyl citrate, or a combination thereof.

An embodiment of the present invention is to provide the bio-based formulation wherein preferably the additive is optionally present.

An embodiment of the present invention is to provide the bio-based formulation wherein preferably the additive is in the concentration range between 2-15 wt %.

An embodiment of the present invention is to provide the bio-based formulation wherein the additive is selected from the group consisting of pigments, anti-fungal agents, lubricants, softener, foaming agents, blowing agents, or a combination thereof.

An embodiment of the present invention is to provide the bio-based formulation wherein the pigments are either organic or inorganic pigment. The pigments are selected from the group consisting of alizarin, Indian yellow, indigo dye, Naphthol red, malachite green, crimson, azo dyes, or a combination thereof.

An embodiment of the present invention is to provide the bio-based formulation wherein the antifungal agents is selected from the group consisting of carbendazim, zinc oxide, benzimidazole, terbinafine, naftifine, ketoconazole, fluconazole, clotrimazole, miconazole, itraconazole, voriconazole, Posaconazole, or a combination thereof.

An embodiment of the present invention is to provide a formulation wherein the lubricants are selected from paraffin wax, natural vegetable oils, or a combination thereof.

An embodiment of the present invention is to provide the bio-based formulation wherein the softener is silicone oil.

An embodiment of the present invention is to provide the bio-based formulation wherein the foaming and blowing agents is selected from hydrazine, sodium bicarbonate, chlorocarbons, azodicarbonamide, titanium hydride, liquid CO₂, isocyanates, or a combination thereof.

In one embodiment, the present invention provides a process for preparing the bio-based formulation comprising agricultural residue, the process comprising:
a. grinding agricultural residue (ARW) to form a powdered ARW having a particle size around 0.2 microns to 50 microns;
b. kneading the powdered ARW along with the thermoplastic binder, stabilizer, plasticizer, colorant, and antifungal agent at about 30-75° C. to form a semi-solid dough;
c. blending the semi-solid dough in a two-roll mill at a temperature of 100-200° C. for about 10-40 minutes to obtain a uniformly blended formulation; and
d. cooling the uniformly blended formulation obtained to a temperature of 75-200° C., where the temperature is based on the consistency of the uniformly blended formulation.

In another embodiment, the present invention provides a process for preparing a synthetic material, the process comprising the steps of:
a. Grinding agricultural residue (ARW) to form a powdered ARW having a particle size around 0.2 microns to 50 microns;
b. Kneading the powdered ARW along with the thermoplastic binder, stabilizer, plasticizer, colorant, and antifungal agent at about 30-75° C. together to form a semi-solid dough;
c. blending the semi-solid dough in a two-roll mill at a temperature of about 100-200° C. for about 10-40 minutes to obtain a uniformly blended formulation;
d. cooling the uniformly blended formulation to a temperature of about 75-200° C., where the temperature is based on the consistency of the uniformly blended formulation, and
e. coating the uniformly blended formulation onto a fabric in the two-roll mill to obtain the synthetic material.

Another embodiment of the present invention is to provide a process for preparing a foamed synthetic material, the process comprising the steps of:
a. Grinding agricultural residue (ARW) to form a powdered ARW having a particle size around 0.2 microns to 50 microns;
b. Kneading the powdered ARW along with the thermoplastic binder, stabilizer, plasticizer, colorant, antifungal agent, and a foaming agent at about 30-75° C. together to form a first semi-solid dough;
c. blending the first semi-solid dough in a two-roll mill at a temperature of about 100-200° C. for about 10-40 minutes to obtain a first uniformly blended formulation;
d. Cooling the first uniformly blended formulation to a temperature of about 75-200° C. where the temperature is based on the consistency of the uniformly blended formulation;
e. coating the first uniformly blended formulation onto a fabric in the two-roll mill to obtain a first coated fabric;
f. Kneading the powdered ARW along with the thermoplastic binder, stabilizer, plasticizer, colorant, and antifungal agent at about 30-75° C. together to form a second semi-solid dough;
g. blending the second semi-solid dough in a two-roll mill at a temperature of about 100-200° C. for about 10-40 minutes to obtain a second uniformly blended formulation;
h. Cooling the second uniformly blended formulation to a temperature of about 75-200° C. where the temperature is based on the consistency of the uniformly blended formulation; and
i. coating the second uniformly blended formulation onto the first coated fabric in the two-roll mill to obtain a foamed synthetic material.

An embodiment of the present invention is to provide a process for preparing a synthetic or foamed synthetic material comprising a fabric coated with the bio-based formulation of the present invention.

An embodiment of the present invention is to provide a process for preparing a synthetic or foamed synthetic material wherein the fabric is a non-woven fabric selected from cotton, wool, polyester, cotton-polyester blend, wool-cotton blend, or wool polyester blend.

Another embodiment of the present invention is to provide a bio-based material comprising a base fabric coated with the formulation of the present invention wherein the bio-based material has excellent tensile strength.

Another embodiment of the present invention is to provide a synthetic or foamed synthetic material which is a high value-added biomaterial that can be employed for several applications such as clothing, furniture, and furnishings, automobiles, accessories, footwear, travel bags, coated sheets, gift boxes, etc.

Another embodiment of the present invention is to provide a high value-added biomaterial wherein the high value-added biomaterial could be synthetic or foamed synthetic leather.

Without limiting the scope of the present invention as described above in any way, the present invention has been further explained through the examples provided below.

### EXAMPLES

### Example 1: Preparation of the Synthetic Material Using Rice Husk

For preparing the synthetic material according to one embodiment of the present invention, firstly rice husk was grounded to form a powder having a particle size around 0.2 microns to 50 microns. Then the powdered rice husk was kneaded along with the raw materials comprising in ethylene-vinyl acetate (EVA), epoxidized soyabean oil, epoxidized palm oil, alizarin, zinc oxide into a kneader at 37-40° C. to obtain a dough which was then blended in a two-roll mill at a temperature of 100-200° C. for 10-40 minutes to obtain a uniformly blended formulation having the weight percentage of individual ingredients as described below:

| Ingredients | Weight % |
|---|---|
| Rice husk | 15 |
| Ethylene Vinyl Acetate (EVA) | 65 |
| Epoxidized Soybean Oil | 17 |
| Alizarin | 2 |
| Zinc Oxide | 1 |

The blended formulation was cooled to a temperature of 75-200° C. The cooled formulation was coated onto a fabric material in the two-roll mill to obtain the synthetic material. The cooling temperature is dependent on the consistency of the blended mixture.

### Example 2: Preparation of the Synthetic Material Using Coffee Grounds

For preparing the synthetic material according to one embodiment of the present invention, firstly coffee grounds were ground to form a powder having a particle size around 0.2 microns to 50 microns. Then the powdered coffee grounds was kneaded along with the raw materials comprising in Acetyl Tributyl Citrate (ATC), EVA+TPU+(compatibilizer), Epoxidized Soybean Oil, Naphthol Red and ZnO into a kneader at 37-40° C. to obtain a dough which was then blended in a two-roll mill at a temperature of 100-200° C. for 10-40 minutes to obtain a uniformly blended formulation having weight percentage of individual ingredients as described below:

| Ingredients | Weight % |
|---|---|
| Coffee Grounds | 24 |
| Acetyl Tributyl Citrate (ATC) | 9 |
| EVA + TPU + (compatibilizer) | 57.5 |
| Epoxidized Soybean Oil | 6 |
| Naphthol Red | 1.3 |
| ZnO | 1.2 |

The blended formulation was cooled to a temperature of 75-200° C. The cooled formulation was coated onto a fabric material in the two-roll mill to obtain the synthetic material. The cooling temperature is dependent on the consistency of the blended mixture.

### Example 3: Preparation of the Synthetic Material Using Grain Husk

For preparing the synthetic material according to one embodiment of the present invention, firstly grain husk was grounded to form a powder having a particle size around 0.2 microns to 50 microns. Then the powdered grain husk was kneaded along with the raw materials comprising in Dioctyl Terephthalate (DOTP), EVA+HDPE, Epoxidized Soybean Oil, Malachite Green and ZnO into a kneader at 37-40° C. to obtain a dough which was then blended in a two-roll mill at a temperature of 100-200° C. for 10-40 minutes to obtain a uniformly blended formulation having weight percentage of individual ingredients as described below:

| Ingredients | Weight % |
|---|---|
| Grain Husk | 14 |
| Dioctyl Terephthalate (DOTP) | 8 |
| EVA + HDPE | 50 |
| Epoxidized Soybean Oil | 2.5 |
| Malachite Green | 1.5 |
| ZnO | 1 |
| Aluminium Trihydroxide | 23 |

The blended formulation was cooled to a temperature of 75-200° C. The cooled formulation was coated onto a fabric material in the two-roll mill to obtain the synthetic material. The cooling temperature is dependent on the consistency of the blended mixture.

### Example 4: Preparation of the Synthetic Material Using Tea Grounds

For preparing the synthetic material according to one embodiment of the present invention, firstly tea grounds were grounded further to form a powder having a particle size around 0.2 microns to 50 microns. Then the powdered tea grounds was kneaded along with the raw materials comprising in Acetyl Tributyl Citrate (ATC), TPU, Epoxidized Palm Oil, Malachite Green, Itraconazole and Azodicarbonamide into a kneader at 37-40° C. to obtain a dough which was then blended in a two-roll mill at a temperature of 100-200° C. for 10-40 minutes to obtain a uniformly blended formulation having weight percentage of individual ingredients as described below:

| Ingredients | Weight % |
|---|---|
| Tea Grounds | 15 |
| Acetyl Tributyl Citrate (ATC) | 17 |
| TPU | 55 |
| Epoxidized Palm Oil | 4 |
| Malachite Green | 1.5 |
| Itraconazole | 0.5 |
| Azodicarbonamide | 7 |

The blended formulation was cooled to a temperature of 75-200° C. The cooled formulation was coated onto a fabric material in the two-roll mill to obtain the synthetic material. The cooling temperature is dependent on the consistency of the blended mixture.

### Example 6: Preparation of the Synthetic Material Using Pistachio Shells

For preparing the synthetic material according to one embodiment of the present invention, firstly Pistachio Shells were grounded to form a powder having a particle size around 0.2 microns to 50 microns. Then the powdered Pistachio Shells were kneaded along with the raw materials comprising in Dioctyl terephthalate (DOTP), SEBS, Indigo Dye, Paraffin Wax and ZnO into a kneader at 37-40° C. to obtain a dough which was then blended in a two-roll mill at a temperature of 100-200° C. for 10-40 minutes to obtain a uniformly blended formulation having weight percentage of individual ingredients as described below:

| Ingredients | Weight % |
|---|---|
| Pistachio Shells | 19 |
| Dioctyl terephthalate (DOTP) | 22 |
| SEBS | 52 |
| Indigo Dye | 1.5 |
| Paraffin Wax | 4 |
| ZnO | 1.5 |

The blended formulation was cooled to a temperature of 75-200° C. The cooled formulation was coated onto a fabric material in the two-roll mill to obtain the synthetic material. The cooling temperature is dependent on the consistency of the blended mixture.

### Example 7: Preparation of the Synthetic Material Using Coconut Coir

For preparing the synthetic material according to one embodiment of the present invention, firstly Coconut Coir was grounded to form a powder having a particle size around 0.2 microns to 50 microns. Then the powdered Coconut Coir was kneaded along with the raw materials comprising in Dioctyl Terephthalate (DOTP), EVA+SEBS, Epoxidized Palm Oil, Carbon Black and Azodicarbonamide into a kneader at 37-40° C. to obtain a dough which was then blended in a two-roll mill at a temperature of 100-200° C. for 10-40 minutes to obtain a uniformly blended formulation having weight percentage of individual ingredients as described below:

| Ingredients | Weight % |
|---|---|
| Coconut Coir | 14 |
| Dioctyl Terephthalate (DOTP) | 12 |
| EVA + SEBS | 65 |
| Epoxidized Palm Oil | 3 |
| Carbon Black | 2 |
| Azodicarbonamide | 4 |

The blended formulation was cooled to a temperature of 75-200° C. The cooled formulation was coated onto a fabric material in the two-roll mill to obtain the synthetic material. The cooling temperature is dependent on the consistency of the blended mixture.

### Example 8: Preparation of the Synthetic Material Using Walnut Shells

For preparing the synthetic material according to one embodiment of the present invention, firstly Walnut Shells was grounded to form a powder having a particle size around 0.2 microns to 50 microns. Then the powdered Walnut Shells was kneaded along with the raw materials comprising in Dioctyl Adipate (DOA), Thermoplastic Starch (TPS), Epoxidized Soybean Oil, Indian Yellow, and Ketoconazole into a kneader at 37-40° C. to obtain a dough which was then blended in a two-roll mill at a temperature of 100-200° C. for 10-40 minutes to obtain a uniformly blended formulation having weight percentage of individual ingredients as described below:

| Ingredients | Weight % |
|---|---|
| Walnut Shells | 5.1 |
| Dioctyl Adipate (DOA) | 6 |
| Thermoplastic Starch (TPS) | 70 |
| Epoxidized Soybean Oil | 16.1 |
| Indian Yellow | 1.3 |
| Ketoconazole | 1.5 |

The blended formulation was cooled to a temperature of 75-200° C. The cooled formulation was coated onto a fabric material in the two-roll mill to obtain the synthetic material. The cooling temperature is dependent on the consistency of the blended mixture.

### Example 9: Preparation of the Synthetic Material Using Orange Seeds

For preparing the synthetic material according to one embodiment of the present invention, firstly Orange Seeds was grounded to form a powder having a particle size around 0.2 microns to 50 microns. Then the powdered Orange Seeds was kneaded along with the raw materials comprising in Dioctyl Adipate (DOA), Thermoplastic Starch (TPS), Acetyl Butyl Citrate (ATC), Carbon Black and Ketoconazole into a kneader at 37-40° C. to obtain a dough which was then blended in a two-roll mill at a temperature of 100-200° C. for 10-40 minutes to obtain a uniformly blended formulation having weight percentage of individual ingredients as described below:

| Ingredients | Weight % |
|---|---|
| Orange Seeds | 20 |
| Dioctyl Adipate (DOA) | 6 |
| Thermoplastic Starch (TPS) | 56 |
| Acetyl Butyl Citrate (ATC) | 14 |
| Carbon Black | 1 |
| Ketoconazole | 1 |
| Hydrazine | 6.5 |

The blended formulation was cooled to a temperature of 75-200° C. The cooled formulation was coated onto a fabric material in the two-roll mill to obtain the synthetic material. The cooling temperature is dependent on the consistency of the blended mixture.

### Examples 10: Preparation of the Synthetic Material Using Corn Cob

For preparing the synthetic material according to one embodiment of the present invention, firstly Corn Cob was grounded to form a powder having a particle size around 0.2 microns to 50 microns. Then the powdered Corn Cob was kneaded along with the raw materials comprising in Acetyl Butyl Citrate, Thermoplastic Starch (TPS), Indian Yellow, ZnO and Silicone Oil into a kneader at 37-40° C. to obtain a dough which was then blended in a two-roll mill at a temperature of 100-200° C. for 10-40 minutes to obtain a uniformly blended formulation having weight percentage of individual ingredients as described below:

| Ingredients | Weight % |
|---|---|
| Corn Cob Powder | 28 |
| Acetyl Butyl Citrate | 19 |
| Thermoplastic Starch (TPS) | 44 |
| Indian Yellow | 1 |
| ZnO | 1 |
| Silicone Oil | 7 |

The blended formulation was cooled to a temperature of 75-200° C. The cooled formulation was coated onto a fabric material in the two-roll mill to obtain the synthetic material. The cooling temperature is dependent on the consistency of the blended mixture.

### Example 11: Preparation of Foamed Synthetic Material

For preparing the foamed synthetic material according to the present invention, firstly rice husk was grounded to form a powder having a particle size around 0.2 microns to 50 microns. Then the powdered rice husk was kneaded along with the raw materials comprising in EVA, epoxidized soyabean oil, epoxidized palm oil, alizarin, zinc oxide and hydrazine into a kneader at 30-75° C. together to form a (semi-solid) dough which was then blended in a two-roll mill at a temperature of 100-200° C. for 10-40 minutes to obtain a uniformly blended formulation as prepared in Example 1.

Cooling the formulation to a temperature of 75-200° C. where the temperature is based on the consistency of the uniformly blended formulation, to coat this formulation onto a fabric material in the two-roll mill to obtain a fabric material coated with foaming formulation.

Further, the powdered rice husk is kneaded along with the raw materials comprising in EVA, epoxidized soyabean oil, epoxidized palm oil, alizarin, zinc oxide in kneader at 30-75° C. without the foaming agent to form a (semi-solid) dough. The dough is then blended in a two-roll mill at a temperature of 100-200° C. for 10-40 minutes to obtain a uniformly blended formulation.

Finally, cooling this formulation to a temperature of 75-200° C. where the temperature is based on the consistency of the uniformly blended formulation, followed by coating the formulation onto the foaming formulation coated fabric material obtained before in the two-roll mill to obtain foamed synthetic foamed material.

### Example 12: Assessment of the Tensile Strength of the Bio-Based Material of the Present Invention

In this study, the inventors of the present invention, cut out 5 different portions from the bio-based material prepared in example 1 to assess the tensile strength of the bio-based material by ASTM D 3039-2006.

TABLE 1
TENSILE STRENGTH TEST (ALONG DIRECTION)
by test method ASTM D 3039-2006

| | | | | | Ult. | |
|---|---|---|---|---|---|---|
| | | | | Tensile | Tensile | Elon- |
| | Width | Thickness | C/s Area | Load | Strength | gation |
| Sr. No. | (mm) | (mm) | (mm2) | (N) | (N/mm2) | (%) |
| 1 | 15 | 0.60 | 9.00 | 213 | 23.67 | 38.40 |
| 2 | 15 | 0.60 | 9.00 | 203 | 22.58 | 36.00 |
| 3 | 15 | 0.60 | 9.00 | 209 | 23.18 | 37.60 |
| 4 | 15 | 0.60 | 9.00 | 214 | 23.81 | 38.40 |
| 5 | 15 | 0.60 | 9.00 | 206 | 22.84 | 36.40 |
| Average | 15 | 0.60 | 9.00 | 209 | 23.21 | 37.36 |

TABLE 2
TENSILE STRENGTH TEST (ACROSS DIRECTION)

| | | | | | Ult. | |
|---|---|---|---|---|---|---|
| | | | | Tensile | Tensile | Elon- |
| | Width | Thickness | C/s Area | Load | Strength | gation |
| Sr. No. | (mm) | (mm) | (mm2) | (N) | (N/mm2) | (%) |
| 1 | 15 | 0.60 | 9.00 | 90 | 9.98 | 198.80 |
| 2 | 15 | 0.60 | 9.00 | 87 | 9.67 | 197.20 |
| 3 | 15 | 0.60 | 9.00 | 91 | 10.14 | 202.40 |
| 4 | 15 | 0.60 | 9.00 | 98 | 10.91 | 237.60 |
| 5 | 15 | 0.60 | 9.00 | 90 | 9.94 | 206.40 |
| Average | 15 | 0.60 | 9.00 | 91.2 | 10.12 | 208.48 |

Thus, from Tables 1 and 2 it can be seen that the by running the same test run in different parts of the fabric, uniform mixing was observed and thus, the synthetic material can be concluded to have uniform strength and elongation. Also, it was observed that there was minimal standard deviation.

### Example 13: Assessment of the Tensile Strength of the Bio-Based Material of the Present Invention in Comparison to Existing Materials

The inventors of the present invention compared the tensile strength of the synthetic material prepared in example 1 and existing materials. The results are provided in the Table 3 provided below:

| | | |
|---|---|---|
| | | Tensile Strength |
| Material | Thickness | (N/mm²) |

| | | | |
|---|---|---|---|
| Naturally | Leather | 1.93 | 39.5 |
| Grown | Muskin | 6.22 | 0.2 |
| Material | Kombucha | 0.29 | 9.7 |
| Coated | PU coated | 1.37 | 10.2 |
| Textiles | Desserto | 0.88 | 20.8 |
| | Appleskin | 1.14 | 14 |
| | Vegea | 0.95 | 9.4 |
| | Teak Leaf | 0.57 | 12.2 |
| Non-wovens | Pinatex | 1.43 | 4.5 |
| of Plant | Snap Pap | 0.57 | 24.9 |
| fibers | | | |

| | | |
|---|---|---|
| Synthetic composite of the | 0.6 | 23.21 |
| present invention | | |

Accordingly, it was observed that the synthetic material is one of the strongest options mentioned as can be observed by the results from the above table 3 above. Further, it can be concluded that the raw materials are environmentally safe, there's no wastewater or toxic effluents, but most importantly the performance of the material is not compromised in comparison to the alternatives.

### Example 14: Heat Aging Test

Heat aging test for the synthetic material prepared in example 1 was carried out. The temperature for performing the heat aging test was 60° C. for 7 Days. After 7 days, the results demonstrated that no dimensional change was seen in the bio-based material however, it was observed that the glossiness reduced.

### Advantages of the Present Invention

The present invention provides several advantages over the conventionally known synthetic material. Moreover, even the process for obtaining this synthetic material is a novel, easy, and eco-friendly process over the known conventional processes. Some of the advantages have been highlighted below:
The present invention is more beneficial than genuine leather as it is free from animal cruelty, no tanning chemicals have been involved. Further, the process of the present invention does not lead to water pollution as no effluent waste is given out and does not involve the use of complicated and extremely lengthy process steps and parameters.
The present invention does not involve the use of any toxic chemicals and is hence eco-friendly.
The present invention involves the use of agricultural waste products and hence the process has a lesser carbon footprint.
The synthetic material of the present invention has better durability, no PU topcoat, and affordable, better tensile strength, further, the process is easier to perform, has a shorter preparation time, larger manufacturing capacity, efficient waste management.

1-20. (canceled)

21. A synthetic or foamed synthetic material comprising of a bio-based formulation, wherein the bio-based formulation comprises:
agricultural residue waste (ARW) in a concentration range of 1-65 wt %;
thermoplastic binder/s in a concentration range of 30-90 wt %;
stabilizer in a concentration range of 1-35 wt %;
plasticizer in a concentration range of 3-30 wt %;
additive in a concentration of 0-20 wt % wherein the additive optionally have a foaming agent.

22. The material as claimed in claim 21, wherein the bio-based formulation is coated on a base fabric which is a non-woven fabric selected from cotton, wool, polyester, cotton-polyester blend, wool-cotton blend, or wool polyester blend.

23. The material as claimed in claim 21, wherein the bio-based formulation comprises
agricultural residue waste in a concentration range of 5-30 wt %;
thermoplastic binder in a concentration range of 50-85 wt %;
stabilizer in a concentration range of 2-30 wt %;
plasticizer in a concentration range of 5-25 wt %;
additive in a concentration of 0-20 wt %.

24. The material as claimed in claim 21, wherein the agricultural residue wastes (ARW) is selected from the group consisting of corn cob, rice husk, grain husk, solid coffee waste, peanut shells, fruit residues, walnut shells, pistachio shells, or a combination thereof.

25. The material as claimed in claim 21, wherein the thermoplastic binder that is selected from the group consisting of ethylene-vinyl acetate (EVA), polypropylene (pp), Polyethylene (PE), Thermoplastic polyurethane (TPU), low-density polyethylene (LDPE) and high-density polyethylene (HDPE), acrylic, polystyrene, polycarbonate, thermoplastic starch (TPS), Teflon, or a combination thereof.

26. The material as claimed in claim 21, wherein the stabilizer is selected from the group consisting of butylated hydroxytoluene, Pentaerythritol tetrakis (3,5-di-tert-butyl-4-hydroxy-hydro cinnamate), epoxidized soybean oil, Tris(2,4-di-tert-butylphenyl) phosphite, bisoctrizole, bemotrizinol, epoxidized palm oil, thiodiethylene bis[3-(3,5-di-tert.-butyl-4-hydroxy-phenyl)propionate], dioctyl adipate, diphenyl isooctyl phosphite, N-isopropyl-N′-phenyl-1,4-phenylenediamine, 3-(4-Hydroxyphenyl) propanoic acid, or a combination thereof.

27. The material as claimed in claim 21, wherein the plasticizer is selected from the group consisting of propane-1,2,3-triol, polyethylene glycol, dibutyl sebacate, epoxidized soybean oil (ESBO), epoxidized palm oil (EPO), Di-iso-octyl phthalate (DIOP), Di-iso-nonyl phthalate (DINP), Di-iso-decyl phthalate (DIDP), Acetyl Tri-Butyl Citrate (ATBC), Dioctyl Adipate (DOA), Di(2-Ethylhexyl) Adipate (DEHA), Di-isononyl-1,2-cyclohexanedicarboxylate (DINCH), Di-isononyl Adipate (DINA), Alkylsulphonic Acid Ester of Phenol (ASE), Di-2-ethyl hexyl phthalate (DEHP), glycerol, sorbitol, butyl citrate, or a combination thereof.

28. The material as claimed in claim 21, wherein the additive is preferably in the concentration range between 2-15 wt %.

29. The material as claimed in claim 21, wherein the additive is optionally selected from pigments, anti-fungal agents, lubricants, softener, foaming agents, blowing agents, or a combination thereof.

30. The material as claimed in claim 21, wherein the pigments are either organic or inorganic pigment selected from alizarin, Indian yellow, indigo dye, Naphthol red, malachite green, crimson, azo dyes, or a combination thereof.

31. The material as claimed in claim 21, wherein the antifungal agents is selected from carbendazim, zinc oxide, benzimidazole, terbinafine, naftifine, ketoconazole, fluconazole, clotrimazole, miconazole, itraconazole, voriconazole, Posaconazole, or a combination thereof.

32. The material as claimed in claim 21, wherein the lubricants are selected from paraffin wax, natural vegetable oils, or a combination thereof.

33. The material as claimed in claim 21, wherein the softener is silicone oil.

34. The material as claimed in claim 21, wherein the foaming and blowing agents is selected from hydrazine, sodium bicarbonate, chlorocarbons, azodicarbonamide, titanium hydride, liquid CO₂, isocyanates, or a combination thereof.

35. The material as claimed in claim 21, wherein the base fabric coated with the bio-based formulation composed of agricultural waste residues wherein the synthetic material has excellent tensile strength and elongation.

36. The material as claimed in claim 35, for use in clothing, furniture and furnishings, automobiles, footwear, travel bags, coated sheets, gift boxes or accessories.

37. A process for preparing a bio-based formulation comprising agricultural residue, the process comprising:
a. grinding agricultural residue waste (ARW) to form a powdered ARW having a particle size around 0.2 microns to 50 microns;
b. kneading the powdered ARW along with the thermoplastic binder, stabilizer, plasticizer, colorant, and additive at about 30-75° C. to form a semi-solid dough;
c. blending the semi-solid dough in a two-roll mill at a temperature of 100-200° C. for about 10-40 minutes to obtain a uniformly blended formulation; and
d. cooling the uniformly blended formulation obtained to a temperature of 75-200° C., where the temperature is based on the consistency of the uniformly blended formulation.

38. The process as claimed in claim 37 comprising obtaining a synthetic material by coating a fabric with the bio-based formulation in a calendering machine/equipment.

39. A process for preparing a foamed synthetic material, the process comprising the steps of:
a. Grinding agricultural residue (ARW) to form a powdered ARW having a particle size around 0.2 microns to 50 microns;
b. Kneading the powdered ARW along with the thermoplastic binder, stabilizer, plasticizer, colorant, antifungal agent, and a foaming agent at about 30-75° C. together to form a first semi-solid dough;
c. blending the first semi-solid dough in a two-roll mill at a temperature of about 100-200° C. for about 10-40 minutes to obtain a first uniformly blended formulation;
d. Cooling the first uniformly blended formulation to a temperature of about 75-200° C. where the temperature is based on the consistency of the uniformly blended formulation;
e. coating the first uniformly blended formulation onto a fabric in the two-roll mill to obtain a first coated fabric;
f. Kneading the powdered ARW along with the thermoplastic binder, stabilizer, plasticizer, colorant, and antifungal agent at about 30-75° C. together to form a second semi-solid dough;
g. blending the second semi-solid dough in a two-roll mill at a temperature of about 100-200° C. for about 10-40 minutes to obtain a second uniformly blended formulation;
h. Cooling the second uniformly blended formulation to a temperature of about 75-200° C. where the temperature is based on the consistency of the uniformly blended formulation; and
i. coating the second uniformly blended formulation onto the first coated fabric in the two-roll mill to obtain a foamed bio-based material.
